(19) United States
(12) Patent Application Publication
(10) Pub. No.: US 2024/0231940 A9
(43) Pub. Date: Jul. 11, 2024

(54) A NON-INTRUSIVE METHOD FOR RESOURCE AND ENERGY EFFICIENT USER PLANE IMPLEMENTATIONS

(71) Applicant: TELEFONAKTIEBOLAGET LM ERICSSON (PUBL), Stockholm (SE)

(72) Inventor: Mattias Rönnblom, Vikingstad (SE)

(21) Appl. No.: 18/546,739

(22) PCT Filed: Feb. 18, 2021
(86) PCT No.: PCT/IB2021/051399

§ 371 Date: Aug. 16, 2023

(51) Int. Cl. G06F 9/50; G06F 9/30

(52) U.S. Cl. CPC G06F 9/505; G06F 9/3009; G06F 2209/5018; G06F 2209/508

(57) ABSTRACT

A method by a network device to dynamically allocate cores to a user plane application based on a processing load of the user plane application. The method includes determining a processing load of the user plane application, where the user plane application has a plurality of worker threads that are configured to poll queues for traffic to process, determining, based on the processing load of the user plane application, that the user plane application is to be allocated a number of cores in the plurality of cores that is different from a current number of cores allocated to the user plane application, allocating the different number of cores in the plurality of cores to the user plane application, and executing the plurality of worker threads of the user plane application using the different number of cores in the plurality of cores instead of the current number of cores.

### TECHNICAL FIELD

Embodiments of the invention relate to the field of computer networks, and more specifically, to dynamically allocating cores of a network device to a user plane application based on a processing load of the user plane application.

### BACKGROUND

User plane applications typically have strict performance characteristics requirements. For example, user plane applications may not introduce excessive wall-time latency or latency jitter in the network and should be efficient in their use of hardware resources. Many user plane applications run on commercial off-the-shelf (COTS) hardware and software (e.g., on a general-purpose central processing unit (CPU) running a general-purpose operating system (OS)).

Current networking stacks of general-purpose OSes introduce too much latency to be used in high-performance user plane implementations. Thus, a common design choice for user plane implementations is for a user plane application (running in user space and not in kernel space) to send/receive user plane traffic directly to/from the network interface card (NIC) (physical or virtualized), thereby bypassing the OS kernel. This path between the user plane application and the NIC is sometimes called the “fast path” and handles the majority of traffic. For performance, legal, and development simplicity reasons, the user plane application is not part of the OS kernel but instead is a regular application running in user space. The user plane application may run on an embedded system or virtualized in a virtual machine (VM) or in a container (as a part of a container runtime (e.g. Docker®)).

The user plane application generally does not rely on hardware interrupts to be notified of arriving traffic but rather one or more worker threads of the user plane application poll the NIC input queues for traffic. The reason for this seemingly wasteful approach is that mechanisms to notify an application running in user space about hardware interrupts are non-existent, slow, and/or complicated. To avoid traffic from lingering in the NIC input queues, the worker threads need to poll the NIC input queues at a sufficiently high frequency.

To maintain continuous polling, many user plane implementations (especially those built on the Data Plane Development Kit (DPDK) framework) follow an implementation model referred to herein as the “default” model, where a subset of the available cores in the system are dedicated to executing the worker threads of the user plane application. These cores are referred to herein as dedicated user plane cores. The OS is configured such that it does not schedule any other processes or threads on these dedicated user plane cores. The user plane application may be run as one OS process with as many worker threads as there are dedicated user plane cores. Each worker thread is “pinned” to a different dedicated user plane core. The OS is effectively bypassed. The user plane application relies on internal mechanisms for task load balancing and inter-thread communication. The user plane application may run on top of a user plane platform/framework (e.g., DPDK) that includes drivers to perform traffic input/output (I/O) and interact with hardware accelerators.

The per-core “pinned” worker threads continuously poll the NIC input queues for traffic to process. In case the traffic processing is arranged into a pipeline (e.g., where each worker thread only performs a portion of the total work needed, per packet), worker threads may also poll software queues (e.g., for core-to-core communications).

The remaining cores in the system, which are referred to herein as non-user plane cores, are used to perform other non-user plane processing such as control plane or management plane processing and running OS-internal threads and interrupt handlers.

In the default model, the worker threads of the user plane application keep the dedicated user plane cores busy even in low-load situations where they perform little to no useful processing work (e.g., traffic processing work as opposed to polling work). From the point of view of both the hardware and the OS, the worker threads always appear to be busy even if they are not performing useful processing work (e.g., because they continually poll the NIC queues and software queues), which effectively disables various power-saving mechanisms of the processor.

### SUMMARY

A method by a network device to dynamically allocate cores to a user plane application based on a processing load of the user plane application, where the network device includes a plurality of cores that are to be used as non-dedicated user plane cores and one or more additional cores that are to be used as non-user plane cores. The method includes determining a processing load of the user plane application, where the user plane application has a plurality of worker threads that are configured to poll queues for traffic to process, determining, based on the processing load of the user plane application, that the user plane application is to be allocated a number of cores in the plurality of cores that is different from a current number of cores allocated to the user plane application, allocating the different number of cores in the plurality of cores to the user plane application, and executing the plurality of worker threads of the user plane application using the different number of cores in the plurality of cores instead of the current number of cores.

A non-transitory machine-readable medium having computer code stored therein, which when executed by a set of one or more processors of a network device, causes the network device to perform operations for dynamically allocating cores to a user plane application based on a processing load of the user plane application, where the network device includes a plurality of cores that are to be used as non-dedicated user plane cores and one or more additional cores that are to be used as non-user plane cores. The operations include determining a processing load of the user plane application, where the user plane application has a plurality of worker threads that are configured to poll queues for traffic to process, determining, based on the processing load of the user plane application, that the user plane application is to be allocated a number of cores in the plurality of cores that is different from a current number of cores allocated to the user plane application, allocating the different number of cores in the plurality of cores to the user plane application, and executing the plurality of worker threads of the user plane application using the different number of cores in the plurality of cores instead of the current number of cores.

A network device to dynamically allocate cores to a user plane application based on a processing load of the user plane application. The network device includes a processor including a plurality of cores to be used as non-dedicated user plane cores and one or more additional cores to be used as non-user plane cores. The network device further includes a non-transitory machine-readable storage medium having stored therein instructions, which when executed by the processor, causes the network device to determine a processing load of the user plane application, where the user plane application has a plurality of worker threads that are configured to poll queues for traffic to process, determine, based on the processing load of the user plane application, that the user plane application is to be allocated a number of cores in the plurality of cores that is different from a current number of cores allocated to the user plane application, allocate the different number of cores in the plurality of cores to the user plane application, and execute the plurality of worker threads of the user plane application using the different number of cores in the plurality of cores instead of the current number of cores.

### BRIEF DESCRIPTION OF THE DRAWINGS

The invention may best be understood by referring to the following description and accompanying drawings that are used to illustrate embodiments of the invention. In the drawings:

FIG. 1 is block diagram illustrating a network device that can dynamically allocate cores to a user plane application depending on the processing load of the user plane application, according to some embodiments.

FIG. 2 is block diagram illustrating the network device allocating less cores to the user plane application because the processing load of the user plane application is determined to be lower, according to some embodiments.

FIG. 3 is a flow diagram of a process for dynamically allocating cores to a user plane application based on a processing load of the user plane application, according to some embodiments.

FIG. 4 is a flow diagram of a process determining a processing load of a user plane application, according to some embodiments.

FIG. 5A illustrates connectivity between network devices (NDs) within an exemplary network, as well as three exemplary implementations of the NDs, according to some embodiments.

FIG. 5B illustrates an exemplary way to implement a special-purpose network device, according to some embodiments.

### DETAILED DESCRIPTION

The following description describes methods and apparatus for improving the energy/resource efficiency of user plane implementations in a non-intrusive manner by dynamically allocating cores of a network device to a user plane application based on a processing load of the user plane application. In the following description, numerous specific details such as logic implementations, opcodes, means to specify operands, resource partitioning/sharing/duplication implementations, types and interrelationships of system components, and/or logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, in the “default” model of user plane implementations, a subset of the available cores in the system are dedicated to executing the worker threads of a user plane application. In this default model, the worker threads of the user plane application keep the dedicated user plane cores busy even in low-load situations where they perform little to no useful processing work (e.g., traffic processing work as opposed to polling work). From the point of view of both the hardware and the operating system (OS), the worker threads always appear to be busy even if they are not performing useful processing work (e.g., because they continually poll the network interface card (NIC) queues and software queues).

This behavior of the default model effectively disables various power-saving mechanisms of the processor (e.g., dynamic voltage and frequency scaling (DVFS) and power management sleep states) and processor-external devices such as double data rate (DDR) memory. Also, the default model prevents the OS scheduler from executing other threads on the dedicated user plane cores even though the worker threads of the user plane application may currently only use a very small fraction of the processor cycles on those cores to perform useful processing work.

One solution that has been proposed to address the drawbacks of the default model is to have the user plane application rely on the OS scheduler for load balancing and to rely on the standard OS inter-process communication (IPC) or thread synchronization primitives for communication between worker threads or processes. However, process context-switching and OS-supported IPC are costly operations, rendering this approach unsuitable for most user plane applications except for “high touch” user plane applications (e.g., user plane applications that perform heavy processing work on each packet, which renders the OS overhead comparatively small).

Another alternative approach to the default model is to extend the underlying user plane platform (e.g. Data Plane Development Kit (DPDK)) with OS kernel-like capabilities such as a light-weight threading implementation (including a load-balancing scheduler), a delayed-work mechanism, and/or the ability to tie an incoming event on a NIC queue or a software communication channel to a handler. Overall, this approach can be seen as moving away from the “polling” approach to a “push” approach. However, this approach is “intrusive” in that it would involve a significant investment in terms of user plane platform development and would require extensive adaptations in the user plane application source code.

Embodiments are disclosed herein that can provide an improvement in energy/resource efficiency of user plane implementations in a non-intrusive manner (e.g., without requiring extensive source code changes to the user plane application and/or the user plane platform/framework). Embodiments may retain an aspect of the default model insofar as there is one worker thread per user plane core. When the processing load of the user plane is determined to be high, each of the worker threads is “pinned” to a user plane core just like in or similar to the default model. However, unlike in the default model, when the load of the user plane application is determined to be lower, the worker threads may be “unpinned” from their respective user plane cores and their scheduling affinity may be set such that they share a subset of the user plane cores. In such situations, the OS scheduler may perform load balancing of the worker threads across the subset of user plane cores.

An embodiment is a method by a network device to dynamically allocate cores to a user plane application based on a processing load of the user plane application. The method includes determining a processing load of the user plane application, where the user plane application has a plurality of worker threads that are configured to poll queues for traffic to process, determining, based on the processing load of the user plane application, that the user plane application is to be allocated a number of cores in the plurality of cores that is different from a current number of cores allocated to the user plane application, allocating the different number of cores in the plurality of cores to the user plane application, and executing the plurality of worker threads of the user plane application using the different number of cores in the plurality of cores instead of the current number of cores. An advantage of embodiments disclosed herein over the default model is that they can, with modest effort, improve resource/energy efficiency and non-user plane performance. Other advantages of embodiments disclosed herein will be apparent to one of ordinary skill in the art in view of the present disclosure.

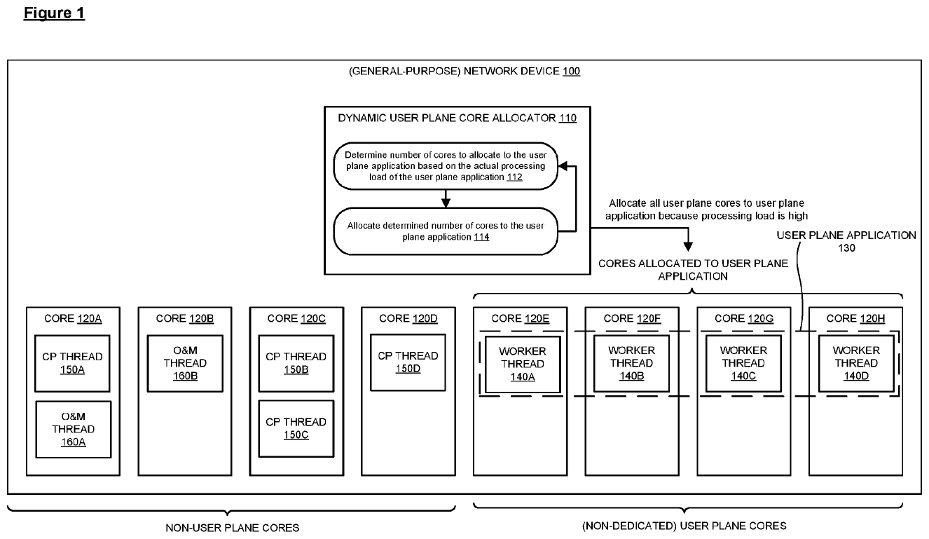

FIG. 1 is block diagram illustrating a network device that can dynamically allocate cores to a user plane application depending on the processing load of the user plane application, according to some embodiments. As shown in the diagram, the network device 100 includes cores 120A-H, which may include cores designated as non-user plane cores 120A-D and cores designated as non-dedicated user plane cores 120E-H. As used herein, non-user plane cores 120A-D are cores that are to be used for executing threads of non-user plane applications. For example, non-user plane cores 120A-D may be used to execute the threads of a control plane application (e.g., control plane (CP) threads 150A-D) and the threads of an operation and management application (e.g., operation and management (O&M) threads 160A and 160B). As used herein, non-dedicated user plane cores are cores that can be used for executing worker threads 140A-D of the user plane application 130 but, as will be further described herein, can also be used to execute threads of non-user plane applications under certain situations (e.g., when the processing load of the user plane application 130 is low). Unless explicitly stated otherwise or the context indicates otherwise, non-dedicated user plane cores may simply be referred to herein as “user plane cores.” It should be noted that the user plane application 130 may perform other “slow path” or “control” processing. For the purpose of this disclosure such processing is classified as being non-user plane processing. In the diagram, a core 120 may be depicted as handling multiple threads, which can be understood to mean that the core 120 can handle the execution of the multiple threads by context-switching between them.

In one embodiment, the network device 100 is a general-purpose network device implemented with commercial off-the-shelf (COTS) hardware and software (e.g., having a general-purpose central processing unit (CPU) running a general-purpose OS (e.g., Linux)). The network device 100 may be deployed as part of a cloud implementation to run the user plane application 130 in the cloud or deployed as a stand-alone network device that runs the user plane application 130. As shown in the diagram, the user plane application 130 (in user space) may have multiple worker threads 140A-D. The worker threads 140 of the user plane application 130 may be configured to poll NIC input queues (physical or virtualized) and/or other types of queues (e.g., a software queues such as software ring buffers) for traffic to process and process traffic that it finds in those queues. In one embodiment, the user plane application 130 has as many worker threads 140 as there are non-dedicated user plane cores. For example, in the example shown in the diagram, there are four worker threads 140 and four non-dedicated user plane cores. However, it should be understood that other embodiments may have a different configuration.

Unlike the dedicated user plane cores used in conventional user plane implementations, the non-dedicated user plane cores 120E-H are not solely dedicated to each executing a single worker thread 140 of the user plane application 130 but, as will be further described herein, can be used to execute threads of non-user plane applications (e.g., control plane application and/or O&M application) under certain situations. While the network device 100 is shown in the diagram as having eight cores 120 with four of the cores (cores 120A-D) being designated as non-user plane cores and four of the cores (cores 120E-H) being designated as non-dedicated user plane cores, other embodiments of the network device 100 may have a different number of cores 120 and/or a different distribution of non-user plane cores and user plane cores within those cores 120.

As shown in the diagram, the network device 100 runs a dynamic user plane core allocator 110. The dynamic user plane core allocator 110 may dynamically adjust the number of (non-dedicated) user plane cores allocated to the user plane application 130 based on the useful processing load of the user plane application 130. As used herein, useful processing load refers to processing load related to performing substantive processing work (e.g., traffic processing work) as opposed to polling work. For example, as shown in the diagram, the dynamic user plane core allocator 110 may perform operation 112 to determine the number of non-dedicated user plane cores to allocate to the user plane application 130 based on the useful processing load of the user plane application 130 and perform operation 114 to allocate the determined number of non-dedicated user plane cores to the user plane application 130. In general, the dynamic user plane core allocator 110 may decide to allocate more of the non-dedicated user plane cores to the user plane application 130 when the processing load of the user plane application 130 is determined to be high and allocate less of the non-dedicated user plane cores to the user plane application 130 when the processing load of the user plane application 130 is determined to be lower.

In the example shown in FIG. 1, it is assumed that the dynamic user plane core allocator 110 determined the processing load of the user plane application 130 to be high (e.g., above a predefined threshold level), and thus allocates all of the user plane cores to the user plane application 130, which effectively “pins” each of the worker threads 140 to its own user plane core similar to the default model. Thus, when the processing load of the user plane application 130 is determined to be high, the user plane implementation may operate similarly to the default model.

However, if the processing load of the user plane application 130 is determined to be lower (e.g., below a predefined threshold level), the dynamic user plane core allocator 110 may allocate less of the non-dedicated user plane cores to the user plane application 130. The dynamic user plane core allocator 110 may allocate the non-dedicated user plane cores to the user plane application 130 based on modifying the core affinity settings of the worker threads 140 (e.g., Linux central processing unit (CPU) affinity settings). As a result, M worker threads will be executed using N non-dedicated user plane cores, where M is greater than N and N is determined based on the processing load of the user plane application 130. Each of the M worker threads may have the same core affinity settings (e.g., so that they are executed using the N non-dedicated user plane cores) and be load balanced by the OS scheduler across the N non-dedicated user plane cores.

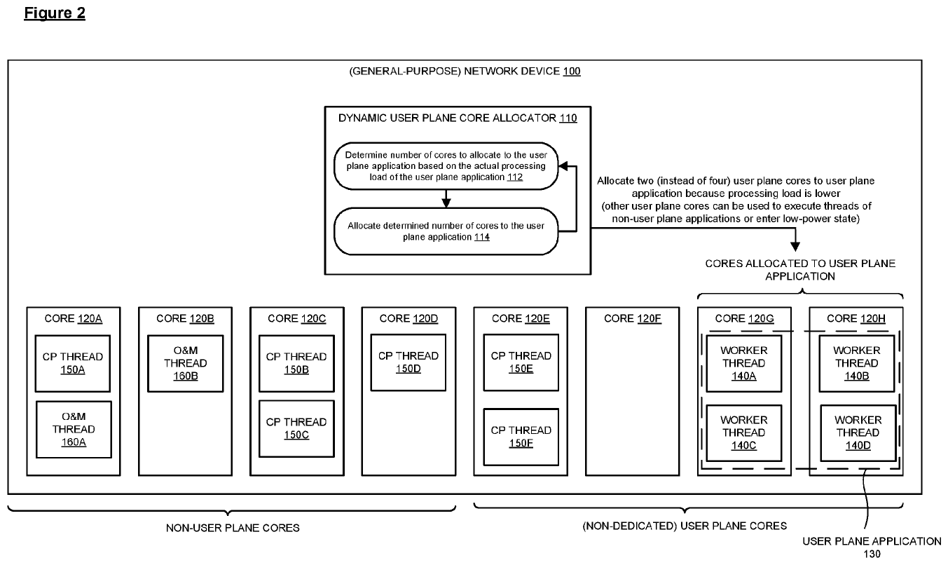

For example, in the example shown in FIG. 2, it is assumed that the dynamic user plane core allocator 110 determined the processing load of the user plane application 130 to be lower, and thus allocates two of the non-dedicated user plane cores (instead of all four of the non-dedicated user plane cores as shown in FIG. 1) to the user plane application 130 (i.e., M=4 and N=2). As a result, the worker threads 140 of the user plane application 130 are executed using two non-dedicated user plane cores (cores 120G and 120H in the example). The other non-dedicated user plane cores (e.g., cores 120E and 120F) may be used to execute threads of non-user plane applications or have no threads executing on them (and thus able to go to sleep). For example, as shown in FIG. 2, CP threads 150E and 150F are executed on core 120E, while core 120F has no threads executing on it and may go to sleep.

The dynamic user plane core allocator 110 may continually repeat operations 112 and 114 to dynamically adjust (i.e., increase or decrease) the number of non-dedicated user plane cores allocated to the user plane application 130 depending on the current processing load of the user plane application 130. In one embodiment, when determining the number of non-dedicated user plane cores to allocate to the user plane application 130, the dynamic user plane core allocator 110 leaves some spare capacity (e.g., “over-provisions” non-dedicated user plane cores to the user plane application 130) in case of a near-future increase in processing load and/or any inaccuracies in the measurement of the current processing load. In one embodiment, the dynamic user plane core allocator 110 increases the number of non-dedicated user plane cores that are allocated to the user plane application 130 more quickly than it decreases it (e.g., since it is safer to allocate more cores than to not allocate enough, assuming performance takes priority over resource/energy efficiency). The dynamic user plane core allocator 110 may be implemented as a thread of the user plane application 130 or as a separate thread from the user plane application 130.

Care may need to be taken that the dynamic user plane core allocator 110 does not interfere with any user plane-internal load balancing. User plane-internal load balancing is typically “immediate” while the dynamic user plane core allocator 110 may track the processing load of the user plane application 130 in a coarser-grained manner (e.g., determining the average processing load over the last 10 milliseconds).

In one embodiment, the dynamic user plane core allocator 110 also determines the processing load of non-user plane applications and may prioritize such non-user applications over the user plane application 130. For example, the dynamic user plane core allocator 110 may decide to reduce the number of non-dedicated user plane cores allocated to the user plane application 130 even though the user plane application 130 is determined to have a high processing load to free some of the non-dedicated user plane cores for non-user plane processing.

In one embodiment, the absolute priority of the worker threads 140 of the user plane application 130 is set so that the worker threads 140 are not (or unlikely to be) preempted by long-executing control plane threads and/or operation and management threads in case any of the non-dedicated user plane cores are shared between the worker threads 140 and other non-user plane threads.

In one embodiment, each worker thread 140 is configured to yield the core 120 it is being executed on to another thread (e.g., by calling the Linux sched_yield( ) function) if there is no traffic to process in the NIC queues, there are no expired timers, and/or there is no pending traffic or events to process from the user plane-internal work scheduler. In one embodiment, to avoid the worker threads 140 of the user plane application 130 from starving other threads being executed using the same core, each worker thread 140 is configured to yield the core that it is being executed on to another thread when the worker thread 140 has occupied the core for longer than a threshold length of time even if it has useful processing work to perform, which forces a context-switch. Such overload situations should be transient in nature assuming reasonable behavior of the dynamic user plane core allocator 110. Since the context-switching penalty may be substantial, a worker thread 140 may be configured to yield the core it is being executed on after it has processed a batch of traffic or after it has occupied the core for more than a threshold length of time.

In one embodiment, to avoid worker threads yielding the cores 120 when all of the non-dedicated user plane cores are allocated to the user plane application 130 (e.g. when operating similarly to the default model), and thus there are no worker threads 140 that are waiting for a core to execute on, the dynamic user plane core allocator 110 may instruct the worker threads 140 not to yield cores that they are being executed on. This may help avoid unnecessary yield-related system calls.

It may be desirable for the OS scheduler to implement a scheduling policy that quickly migrates worker threads 140 from a busy non-dedicated user plane core to one that is currently idle (but still within the subset of non-dedicated user plane cores currently allocated to the user plane application 130). In one embodiment, any limitations on absolute-priority processing time expenditure (e.g. Linux real-time throttling) is disabled. It may be desirable to avoid worker threads 140 from starving important kernel threads. Thus, in one embodiment, kernel threads are not executed on the non-dedicated user plane cores or assigned higher priority than the worker threads 140 of the user plane application 130.

As mentioned above, the dynamic user plane core allocator 110 may determine the number of non-dedicated user plane cores to allocate to the user plane application 130 based on the processing load of the user plane application 130. The dynamic user plane core allocator 110 may determine/measure the processing load of the user plane application 130 using one or more techniques. A sleep-induced load measurement technique, a self-reported load measurement technique, and a queue-based load measurement technique are described herein below.

Processing Load Measurement Techniques

Sleep-Induced Processing Load Measurement Technique

In one embodiment, each worker thread 140 of the user plane application 130 is configured to go to sleep for a short length of time (e.g., by calling the Linux usleep( ) function) when the worker thread determines that it has no useful processing work to perform (e.g., there is no traffic waiting in the NIC or software queues). This allows the processor usage times of the worker threads 140 (which the OS typically keeps track of) to correspond to the actual useful processing work performed by the worker threads 140. The dynamic user plane core allocator 110 may then determine the processing load of the user plane application 130 based on querying the OS for the processor usage times of the worker threads 140 (e.g., the processor usage times may be determined via the Linux/proc file system).

It should be noted that some care is needed when selecting a suitable sleep length. Sleep lengths that are too short will make the OS-maintained processor usage times to be an over-estimation since a large portion of the processor usage times will be spent performing context-switching tasks. However, sleep lengths that are too long may introduce unacceptably long port-to-port wall time latency and latency jitter for traffic being processed by the user plane application 130. If the port-to-port latency requirement is somewhat relaxed, it may be possible for the worker threads 140 to sleep long enough to allow the non-dedicated user plane cores allocated to the user plane application 130 to enter into a sleep state (or other low-power state) to improve efficiency. Also, it may allow for OS or hardware controlled dynamic voltage and frequency scaling (DVFS) to be activated, further improving resource/energy efficiency. High enough OS timer resolution may be needed to facilitate shorter sleep lengths (e.g., less than 100 microseconds). It has been found that the Linux kernel's high-resolution timers are granular enough to support viable implementations.

In one embodiment, if a load balancer that is internal to the user plane application 130 is used to distribute processing work to the worker threads 140, the dynamic user plane core allocator 110 may configure the load balancer to only schedule processing work to a subset of the worker threads 140 while the other worker threads can be configured to sleep for longer periods of time.

A benefit of having worker threads 140 of the user plane application 130 go to sleep is that at medium load, the worker threads 140 will tend to process packets in batches, which is more efficient than processing one packet at a time. The latter would occur if the packets are processed “immediately” as they become available (e.g., using a hardware interrupt).

In one embodiment, each worker thread 140 of the user plane application 130 is configured to adaptively determine the length of time that the worker thread is to go to sleep based on a sleep history of the worker thread (e.g., instead of going to sleep for a fixed length of time each time). For example, a worker thread 140 may determine its sleep length to be a length within a predefined range and determine the sleep length using the following heuristic or similar heuristic. At startup, the sleep length is a default length within the predefined range; upon waking up from sleep and finding there is no processing work to perform (e.g., no traffic in the NIC/software queues), the sleep length is increased by a fixed amount (but not increased to be above the maximum of the predefined range); upon waking up from sleep and finding there is processing work to perform (e.g., there is traffic waiting in the NIC/software queues), the sleep length is decreased by a fixed amount (but not decreased to be below the minimum of the predefined range). In one embodiment, if the user plane application 130 has very tight deadlines for user plane-internal timer expiration, the next (e.g., closest in time) timeout can be used as an input to the decision on how long to go to sleep.

Having the worker threads take short sleeps may help nudge the OS scheduler to perform load balancing and may also help the dynamic user plane core allocator 110 keep track of the processing load of the user plane application 130.

Self-Reported Processing Load Measurement Technique

In one embodiment, each worker thread 140 of the user plane application 130 is configured to keep track of the length of time during which the worker thread performs useful processing work and to report the length of time. The dynamic user plane core allocator 110 may access the lengths of time reported by the respective worker threads 140 and determine the processing load of the user plane application 130 based on the reported lengths of times.

In one embodiment, to avoid overload, the dynamic user plane core allocator 110 also factors in the context-switching overhead (e.g., in addition to the lengths of time reported by the worker threads 140) when determining the number of non-dedicated user plane cores to allocate to the user plane application 130 since there is likely to be more context-switching (e.g., between the worker threads 140) occurring as the number of non-dedicated user plane cores allocated to the user plane application 130 is decreased.

Queue-Based Processing Load Measurement Technique

In one embodiment, the dynamic user plane core allocator 110 determines the processing load of the user plane application 130 based on queue depth measurements of queues used by the user plane application 130 (e.g., NIC queues and/or software queues). If the user plane traffic processing is arranged as a pipeline with an internal load balancer, the number of in-flight packets in the load balancing scheduler may be used to determine the processing load of the user plane application 130. Queue depth measurements provide an indication of momentary load, and thus the queue depths may be sampled and averaged over time to provide a more accurate reflection of the processing load over time. Queue buildup tends to happen when the processing load is near maximum load, and thus queue-based processing load measurement techniques may tend to detect near-future overload later than other techniques such as those mentioned above that are based on tracking processor usage times.

While certain techniques for determining/measuring the processing load of the user plane application 130 are described above, it should be understood that different embodiments may use processing load measurement techniques than those described herein.

If a technique that is internal to the user plane is used to determine processing load (e.g., the self-reported processing load measurement technique or queue-based processing load measurement technique), there may be less of a need to have idle worker threads 140 go to sleep. Such worker threads 140 may only need to yield the core it is executing on upon becoming idle. However, this may cause busy worker threads 140 to consume all of the available processing time, thus preventing free time on cores currently allocated to the user plane application 130 to be used by other threads. Thus, in one embodiment, each of the worker threads 140 is configured to yield the core that it is being executed on to another thread when the worker thread 140 has occupied the core for longer than a threshold length of time.

In Linux, short sleep function calls (e.g., usleep( )) may be used to induce the OS scheduler to migrate worker threads 140 between non-dedicated user plane cores. If no such function calls are made, there may be a risk that the OS scheduler will fail to properly load balance the worker threads 140 across the non-dedicated user plane cores allocated to the user plane application 130. In one embodiment, if the purpose of the short sleep function call is only to induce load balancing, the sleep lengths may be very short to avoid most of the “artificial” port-to-port latency that sleeping worker threads 140 would otherwise cause.

Ensuring Preemption Safety

User plane platforms such as DPDK include many low-level constructs (and higher-level modules depending on them) that are not preemption safe (e.g., DPDK uses Linux kernel-type primitives but in an environment where preemption cannot be disabled). Preemption in this context means the act of interrupting the execution of a thread, generally performed by the OS kernel, usually in order to run another thread or an interrupt service routine (ISR). The “unsafe” use of these platform functions may cause severe performance issues, but generally does not impact correctness. Examples of unsafe preemption that can occur are provided below.

### Spinlock Example

A thread TO running on core C0 acquires a spinlock L. The OS kernel decides to preempt T0, and replace it with a thread T1, before T0 has unlocked L (i.e. within the critical section). On another core C1, a thread T2 attempts to acquire L. The spinlock L is taken, so T2 will “spin,” waiting for the lock to be unlocked. If T1 either is preempted or voluntarily gives up the core in a short time, this adverse situation is quickly resolved, assuming T0 will be replacing T1. If T1 runs for a long time, T2 will wait for L for a long time.

The situation gets worse if thread T0 is preempted and replaced not by T1, but by T2. Then the system will make no progress throughout the “time slice” (i.e., the length of time until T2 is preempted).

This problem is the primary reason why the default model requires each user plane worker thread 140 to run on a dedicated core, and preferably with as little interference as possible from other threads and other sources of interruptions (e.g., interrupts and kernel-level lock contention).

### Worker-to-Worker Messaging Example

It is common in DPDK to use lock-less rings for intra-process communication between worker threads 140. This works well in the default model but may break down if the sender and receiver worker threads are scheduled on the same core.

For example, a worker thread A may send an event (e.g. packet) to worker thread B and wait for a response. Worker thread A may wait for the event and upon receiving the event, enqueue an event in response. The two threads are using two communication rings (r0 and r1) for this purpose.

In the case where both worker threads A and B are scheduled on the same core, worker thread A may, after sending the initial request event, in a manner typical to user plane platforms such as DPDK, repeatedly poll the ring for a response. This polling may continue until the worker thread A is preempted by the operating system. In case of a regular time-sliced, fair scheduler (e.g. Linux SCHED OTHER), worker thread A may run for tens or even hundreds of milliseconds. This wasteful behavior may severely degrade performance.

This problem is more likely to occur than the spinlock problem, since spinlock critical sections are typically short, and thus preemption is unlikely to occur, but a situation where the sender and receiver are scheduled on the same core is more likely (and will always happens when a single user plane core is used).

In one embodiment, to ensure preemption safety, embodiments retain the following promises of the default model: (1) a worker thread 140 will never be preempted by another worker thread; (2) a worker thread 140 will only experience brief other interruptions (e.g., by non-user plane threads such an OS kernel threads or ISRs).

In one embodiment, these promises are achieved by assigning all of the worker threads 140 the same absolute (scheduling) priority and using a scheduling policy (e.g. the Linux SCHED FIFO real-time scheduling policy) that promises: (1) a thread will not be preempted and replaced by a thread with the same absolute priority; and (2) same-priority processes are kept in a list and executed in a round-robin fashion—when the thread yields the CPU, it will be put at the end of the list.

This way, a worker thread to worker thread context switch will only happen voluntarily, by the worker thread either yielding the core (e.g., by calling the sched_yield( ) function) or going to sleep (e.g., by calling the usleep( ) function or other system call that (potentially) puts the thread to sleep).

Embodiments may thus ensure that the user plane platform and/or worker threads 140 of the user plane application 130 are never involuntarily preempted in “unsafe” regions or states, and may yield the core when it is safe to do so (e.g., when no spinlocks are held, not in the middle of a lock-less ring operation, etc.). In one embodiment, yield-related function calls are inserted at the end of code for processing a batch of packets/events in the worker thread's main loop.

Configuring worker threads 140 with equal real-time absolute priority and the use of a real-time first-in-first-out (FIFO)-type scheduling policy, in combination with the worker threads 140 being configured only explicitly yield the core it is executing on at safe points, is a means to working around user plane application and user plane platform/framework preemption safety issues.

In one embodiment, the ability to dynamically adjust the number of cores allocated to the user plane application 130 may be used to perform in-service upgrades. For example, assuming that the in-service upgrade is performed when less than fifty percent of the user plane capacity is being used, the number of non-dedicated user plane cores allocated to the user plane application 130 may be decreased in half (or approximately half). The freed non-dedicated user plane cores may then be used to run the new/upgraded user plane application 130, after which traffic from the “old” instance is redirected to the “new” instance. The system may then initiate a traffic migration process, after which the “old” instance may be shut down and all of the non-dedicated user plane cores can be allocated to the “new” instance.

An advantage of embodiments disclosed herein over the default model is that they can, with modest effort (e.g., without requiring extensive source code changes to the user plane application 130 and/or the user plane platform/framework), improve resource/energy efficiency and non-user plane performance. For example, the non-dedicated user plane cores freed when the processing load of the user plane application 130 is lower may either enter a low-power state, reducing energy consumption, or be used to execute threads of non-user plane applications, thereby improving resource/energy efficiency and/or non-user plane performance (e.g., control or management plane performance). Embodiments may allow for scaling up and scaling down the user plane capacity in a matter of milliseconds in the face of changed network conditions. Embodiments are “non-intrusive” in nature in that they allow a legacy user plane application, written according to the default model, to quickly and with a relatively modest effort to become more energy efficient and performant. Embodiments are based on the astute realization that there is nothing in the user plane platform/framework or in the user plane application that requires the default model-style worker thread-to-core pinning and that although context-switching and the use of general-purpose load balancing is less than ideal to attain maximum throughput, its overhead is acceptable at lower user plane loads.

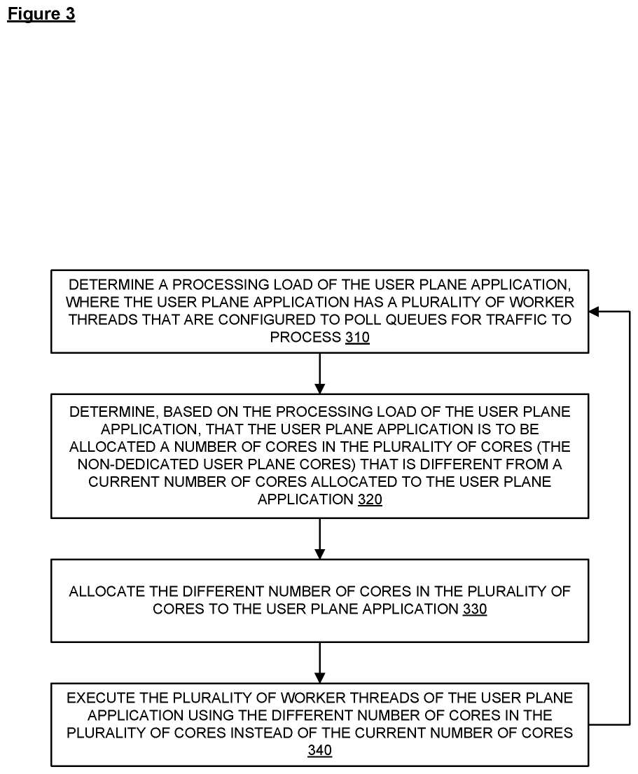

FIG. 3 is a flow diagram of a process for dynamically allocating cores to a user plane application based on a processing load of the user plane application, according to some embodiments. In one embodiment, the process is implemented by a network device 100 that includes a plurality of cores that are to be used as non-dedicated user plane cores and one or more additional cores that are to be used as non-user plane cores.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

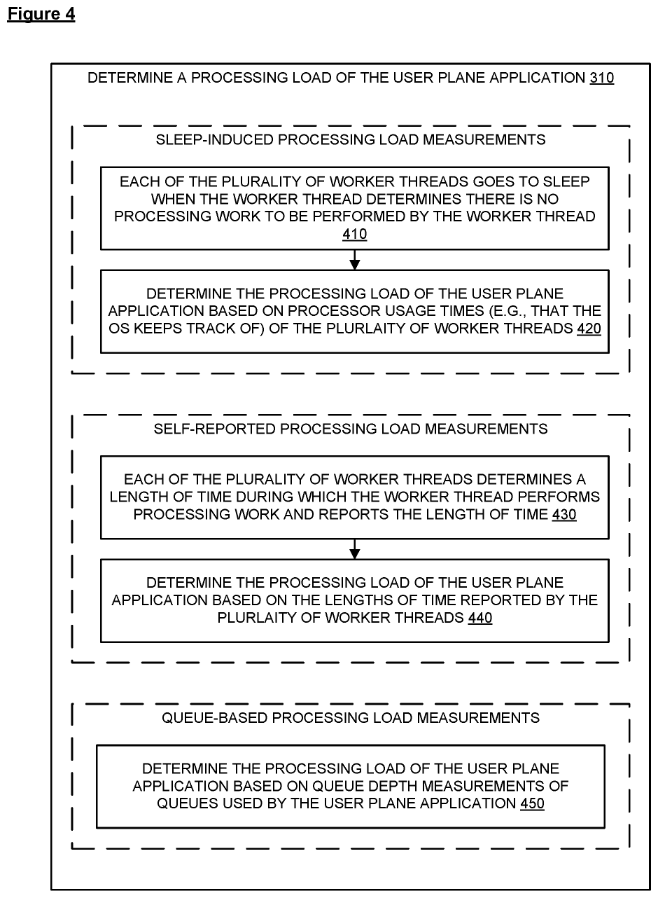

At block 310, the network device determines a processing load of the user plane application, where the user plane application has a plurality of worker threads that are configured to poll queues for traffic to process. In one embodiment, the total number of worker threads in the plurality of worker threads is equal to the total number of cores in the plurality of cores. In one embodiment, each of the plurality of worker threads is configured to yield a core that the worker thread is being executed on to another worker thread when the worker thread has occupied the core for a length of time that is longer than a threshold length of time. In this case, in one embodiment, the network device instructs the plurality of worker threads not to yield cores that the plurality of worker threads are being executed on in response to a determination that all of the plurality of cores are allocated to the user plane application. As will be further described herein with reference to FIG. 4, the network device may determine/measure the processing load of the user plane application using a sleep-induced processing load measurements, self-reported processing load measurements, or queue-based processing load measurements (or a combination thereof).

At block 320, the network device determines, based on the processing load of the user plane application, that the user plane application is to be allocated a number of cores in the plurality of cores (the non-dedicated user plane cores) that is different from a current number of cores allocated to the user plane application.

At block 330, the network device allocates the different number of cores in the plurality of cores to the user plane application. In one embodiment, the different number of cores in the plurality of cores is allocated to the user plane application based on modifying core affinity settings of the plurality of worker threads.

At block 340, the network device executes the plurality of worker threads of the user plane application using the different number of cores in the plurality of cores instead of the current number of cores. In one embodiment, the network device executes a thread of a non-user plane application on one of the cores in the plurality of cores that is not currently allocated to the user plane application.

In one embodiment, the number of cores in the plurality of cores that are allocated to the user plane application is increased more quickly than it is decreased.

In one embodiment, all of the plurality of worker threads are assigned a same scheduling priority, and where the plurality of worker threads are scheduled for execution using a first-in-first-out scheduling policy (e.g., to ensure preemption safety).

In one embodiment, the network device performs in-service upgrades by executing one or more threads of an upgraded version of the user plane application using one or more cores in the plurality of cores that are not currently allocated to the user plane application, redirecting network traffic from the user plane application to the upgraded version of the user plane application, terminating the one or more threads of the user plane application after the network traffic is redirected, and allowing all of the plurality of cores to be allocated to the upgraded version of the user plane application after the user plane application is terminated.

FIG. 4 is a flow diagram of a process determining a processing load of a user plane application, according to some embodiments. The diagram shows operations for performing sleep-induced processing load measurements, self-reported processing load measurements, and queue-based processing load measurements. The network device may determine the processing load of the user plane application (e.g., perform operation of block 310) using any of these techniques.

For the sleep-induced processing load measurement, at block 410, each of the plurality of worker threads goes to sleep when the worker thread determines that there is no processing work to be performed by the worker thread. In one embodiment, each of the plurality of worker threads is configured to determine a length of time that the worker thread is to go to sleep based on a sleep history of the worker thread. At block 420, the processing load of the user plane application is determined based on processor usage times (e.g., that the OS keeps track of) of the plurality of worker threads.

For the self-reported processing load measurement, at block 430, each of the plurality of worker threads determines a length of time during which the worker thread performs processing work (e.g., useful traffic processing work as opposed to polling work) and reports the length of time. At block 440, the processing load of the user plane application is determined based on the lengths of time reported by the plurality of worker threads.

For the queue-based processing load measurement, at block 450, the processing load of the user plane application is determined based on queue depth measurements of queues used by the user plane application (e.g., NIC queues and/or software queues).

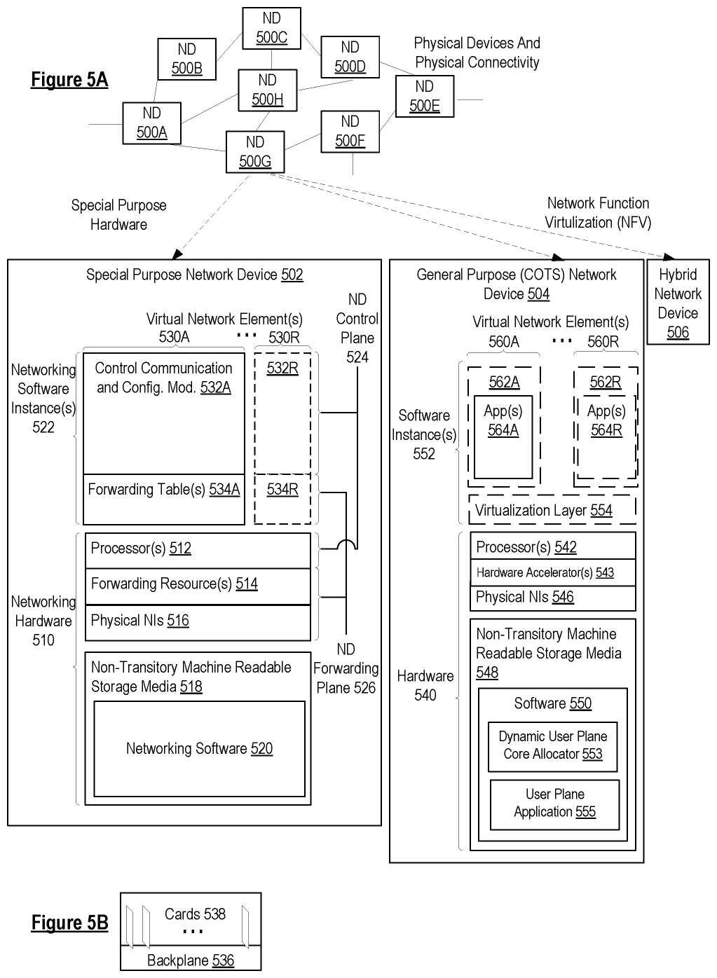

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between 500A-500B, 500B-500C, 500C-500D, 500D-500E, 500E-500F, 500F-500G, and 500A-500G, as well as between 500H and each of 500A, 500C, 500D, and 500G. These NDs are physical devices, and the connectivity between these NDs can be wireless or wired (often referred to as a link). An additional line extending from NDs 500A, 500E, and 500F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application-specific integrated-circuits (ASICs) and a special-purpose operating system (OS); and 2) a general purpose network device 504 that uses common off-the-shelf (COTS) processors and a standard OS.

The special-purpose network device 502 includes networking hardware 510 comprising a set of one or more processor(s) 512, forwarding resource(s) 514 (which typically include one or more ASICs and/or network processors), and physical network interfaces (NIs) 516 (through which network connections are made, such as those shown by the connectivity between NDs 500A-H), as well as non-transitory machine readable storage media 518 having stored therein networking software 520. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

The special-purpose network device 502 is often physically and/or logically considered to include: 1) a ND control plane 524 (sometimes referred to as a control plane) comprising the processor(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the processor(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (ID S), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors), hardware accelerators 543, and physical NIs 546, as well as non-transitory machine readable storage media 548 having stored therein software 550. During operation, the processor(s) 542 execute the software 550 (e.g., with the assistance of hardware accelerators 543) to instantiate one or more sets of one or more applications 564A-R. While one embodiment does not implement virtualization, alternative embodiments may use different forms of virtualization. For example, in one such alternative embodiment the virtualization layer 554 represents the kernel of an operating system (or a shim executing on a base operating system) that allows for the creation of multiple instances 562A-R called software containers that may each be used to execute one (or more) of the sets of applications 564A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 554 represents a hypervisor (sometimes referred to as a virtual machine monitor (VMM)) or a hypervisor executing on top of a host operating system, and each of the sets of applications 564A-R is run on top of a guest operating system within an instance 562A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by linking directly with an application only a limited set of libraries (e.g., from a library operating system (LibOS) including drivers/libraries of OS services) that provide the particular OS services needed by the application. As a unikernel can be implemented to run directly on hardware 540, directly on a hypervisor (in which case the unikernel is sometimes described as running within a LibOS virtual machine), or in a software container, embodiments can be implemented fully with unikernels running directly on a hypervisor represented by virtualization layer 554, unikernels running within software containers represented by instances 562A-R, or as a combination of unikernels and the above-described techniques (e.g., unikernels and virtual machines both run directly on a hypervisor, unikernels and sets of applications that are run in different software containers).

The instantiation of the one or more sets of one or more applications 564A-R, as well as virtualization if implemented, are collectively referred to as software instance(s) 552. Each set of applications 564A-R, corresponding virtualization construct (e.g., instance 562A-R) if implemented, and that part of the hardware 540 that executes them (be it hardware dedicated to that execution and/or time slices of hardware temporally shared), forms a separate virtual network element(s) 560A-R.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments are illustrated with each instance 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 562A-R to VNEs also apply to embodiments where such a finer level of granularity and/or unikernels are used.

In certain embodiments, the virtualization layer 554 includes a virtual switch that provides similar forwarding services as a physical Ethernet switch. Specifically, this virtual switch forwards traffic between instances 562A-R and the physical NI(s) 546, as well as optionally between the instances 562A-R; in addition, this virtual switch may enforce network isolation between the VNEs 560A-R that by policy are not permitted to communicate with each other (e.g., by honoring virtual local area networks (VLANs)).

In one embodiment, software 550 includes code for a dynamic user plane core allocator 553 and user plane application 555, which when executed by processor(s) 542, causes the general purpose network device 504 to perform operations of one or more embodiments of the present invention as part of software instances 562A-R (e.g., dynamically allocate cores to the user plane application 555).

The third exemplary ND implementation in FIG. 5A is a hybrid network device 506, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

In the foregoing specification, embodiments have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method by a network device to dynamically allocate cores to a user plane application based on a processing load of the user plane application, wherein the network device includes a plurality of cores that are to be used as non-dedicated user plane cores and one or more additional cores that are to be used as non-user plane cores, the method comprising:
determining a processing load of the user plane application, wherein the user plane application has a plurality of worker threads that are configured to poll queues for traffic to process;
determining, based on the processing load of the user plane application, that the user plane application is to be allocated a number of cores in the plurality of cores that is different from a current number of cores allocated to the user plane application;
allocating the different number of cores in the plurality of cores to the user plane application; and
executing the plurality of worker threads of the user plane application using the different number of cores in the plurality of cores instead of the current number of cores.

2. The method of claim 1, wherein the different number of cores in the plurality of cores is allocated to the user plane application based on modifying core affinity settings of the plurality of worker threads.

3. The method of claim 1, further comprising:
executing a thread of a non-user plane application on one of the cores in the plurality of cores that is not currently allocated to the user plane application.

4. The method of claim 1, wherein a total number of worker threads in the plurality of worker threads is equal to a total number of cores in the plurality of cores.

5. The method of claim 1, wherein each of the plurality of worker threads is configured to yield a core that the worker thread is being executed on to another worker thread when the worker thread has occupied the core for a length of time that is longer than a threshold length of time.

6. The method of claim 5, further comprising:
instructing the plurality of worker threads not to yield cores that the plurality of worker threads are being executed on in response to a determination that all of the plurality of cores are allocated to the user plane application.

7. The method of claim 1, wherein each of plurality of worker threads is configured to go to sleep when the worker thread determines that there is no processing work to be performed by the worker thread.

8. The method of claim 7, wherein the processing load of the user plane application is determined based on processor usage times of the plurality of worker threads.

9. The method of claim 7, wherein each of the plurality of worker threads is configured to determine a length of time that the worker thread is to go to sleep based on a sleep history of the worker thread.

10. The method of claim 1, wherein each of the plurality of worker threads is configured to keep track of a length of time during which the worker thread performs processing work and to report the length of time.

11. The method of claim 10, wherein the processing load of the user plane application is determined based on the lengths of times reported by the plurality of worker threads.

12. The method of claim 1, wherein the processing load of the user plane application is determined based on queue depth measurements of queues used by the user plane application.

13. The method of claim 1, wherein all of the plurality of worker threads are assigned a same scheduling priority, and wherein the plurality of worker threads are scheduled for execution using a first-in-first-out scheduling policy.

14. The method of claim 1, wherein the number of cores in the plurality of cores that are allocated to the user plane application is increased more quickly than it is decreased.

15. The method of claim 1, further comprising:
executing one or more threads of an upgraded version of the user plane application using one or more cores in the plurality of cores that are not currently allocated to the user plane application;
redirecting network traffic from the user plane application to the upgraded version of the user plane application;
terminating the one or more threads of the user plane application after the network traffic is redirected; and
allowing all of the plurality of cores to be allocated to the upgraded version of the user plane application after the user plane application is terminated.

16. A non-transitory machine-readable medium having computer code stored therein, which when executed by a set of one or more processors of a network device, causes the network device to perform operations for dynamically allocating cores to a user plane application based on a processing load of the user plane application, wherein the network device includes a plurality of cores that are to be used as non-dedicated user plane cores and one or more additional cores that are to be used as non-user plane cores, the operations comprising:
determining a processing load of the user plane application, wherein the user plane application has a plurality of worker threads that are configured to poll queues for traffic to process;
determining, based on the processing load of the user plane application, that the user plane application is to be allocated a number of cores in the plurality of cores that is different from a current number of cores allocated to the user plane application;
allocating the different number of cores in the plurality of cores to the user plane application; and
executing the plurality of worker threads of the user plane application using the different number of cores in the plurality of cores instead of the current number of cores.

17. The non-transitory machine-readable medium of claim 16, wherein the different number of cores in the plurality of cores is allocated to the user plane application based on modifying core affinity settings of the plurality of worker threads.

18. The non-transitory machine-readable medium of claim 16, wherein the operations further comprise:
executing a thread of a non-user plane application on one of the cores in the plurality of cores that is not currently allocated to the user plane application.

19. A network device to dynamically allocate cores to a user plane application based on a processing load of the user plane application, the network device comprising:
a processor including a plurality of cores to be used as non-dedicated user plane cores and one or more additional cores to be used as non-user plane cores; and
a non-transitory machine-readable storage medium having stored therein instructions, which when executed by the processor, causes the network device to:
determine a processing load of the user plane application, wherein the user plane application has a plurality of worker threads that are configured to poll queues for traffic to process,
determine, based on the processing load of the user plane application, that the user plane application is to be allocated a number of cores in the plurality of cores that is different from a current number of cores allocated to the user plane application,
allocate the different number of cores in the plurality of cores to the user plane application, and
execute the plurality of worker threads of the user plane application using the different number of cores in the plurality of cores instead of the current number of cores.

20. The network device of claim 19, wherein each of plurality of worker threads is configured to go to sleep when the worker thread determines that there is no processing work to be performed by the worker thread, and wherein the processing load of the user plane application is determined based on processor usage times of the plurality of worker threads.
